(19) United States
(12) Patent Application Publication
(10) Pub. No.: US 2009/0235579 A1
(43) Pub. Date: Sep. 24, 2009

(54) METHOD OF CULTURING AGARICUS BISPORUS MYCELIUM AND MEDIUM FOR CULTURING THE SAME

(75) Inventors: Young-Duk Kim, Seoul (KR); Yong-Hwi Kim, Seoul (KR)

Correspondence Address: CANTOR COLBURN, LLP, 20 Church Street, 22nd Floor, Hartford, CT, 06103, US

(73) Assignee: CJ CORP., Seoul (KR)

(21) Appl. No.: 12/302,469

(22) PCT Filed: May 25, 2007
(86) PCT No.: PCT/KR2007/002555

§ 371 Date: Nov. 25, 2008

(30) Foreign Application Priority Data
May 25, 2006 (KR) 10-2006-0047117

(51) Int. Cl. A01G 1/04

(52) U.S. Cl. 47/1.1

(57) ABSTRACT

Provided are a method of culturing Agaricus bisporus mycelium, the method comprising culturing Agaricus bisporus mycelium or spores thereof in a liquid medium comprising sugar cane extract, and a medium for culturing the Agaricus bisporus mycelium.

### TECHNICAL FIELD

The present invention relates to a method of liquid culturing Agaricus bisporus mycelium.

### BACKGROUND ART

Agaricus bisporus is a mushroom that belongs to Agaricales Agaricaceae. As a conventional method of culturing Agaricus bisporus mycelium, a solid culture method and a liquid culture method have been known. The solid culture method has disadvantages in that a culture time is long, a probability of contamination is high, and it is difficult to automate an operation of recovering only mycelia after culture is terminated.

Compared to the solid culture method, the liquid culture method of Agaricus bisporus mycelium has advantages of a lower probability of contamination, and mass-cultivation in a relatively compact space for a short period of time. A paper written by Hunfeid et al. (Mycology 44: 605-611, 1952) discloses a method of liquid culturing Agaricus bisporus mycelium with shaking and oxygen supply. In addition, a paper written by Fraser et al. (Mushroom Sci. 3:190-200, 1956) describes that yeast extract and casein facilitate a growth of Agaricus bisporus mycelium. Also, Korean Patent Publication No. 1997-0027295 discloses a method of liquid culturing Basidiomycetes using at least one selected from the group consisting of sugar, maltose, fructose, glucose, sucrose, malt extract and starch syrup, as a carbon source. However, the liquid culture method has disadvantages in that a culture time is relatively long, and since monosaccharide and disaccharide are used, it has high costs, and is thereby not suitable for mass culture.

As seen in the prior art described above, there is still a need for developing a method of culturing Agaricus bisporus mycelium using medium components that are inexpensive to be suitable for mass culture and support high growth of mycelium to reduce the culture time and thus the contamination probability.

### DISCLOSURE OF THE INVENTION

The present invention provides a method of efficiently culturing Agaricus bisporus mycelium.

The present invention also provides a medium for culturing Agaricus bisporus mycelium.

According to an aspect of the present invention, there is provided a method of culturing Agaricus bisporus mycelium, comprising culturing Agaricus bisporus mycelium or spores thereof in a liquid medium comprising sugar cane extract.

The sugar cane extract may have a concentration of 10-30 g/l. When the concentration of the sugar cane extract is less than 10 g/l, Agaricus bisporus mycelium does not grow enough. When the concentration of the sugar cane extract is greater than 30 g/l, an osmotic pressure is high and it is not cost-effective. Thus, the concentration is preferably in the range of 10-30 g/l. The sugar cane extract is mainly used as a carbon source and a growth factor source. The term “sugar cane extract” refers to unrefined extract sugar prepared by extracting a juice and then concentrating and crystallizing the juice. The sugar cane extract can be directly prepared or commercially available.

The medium may further comprise nutrients such as a nitrogen source, phosphoric acid, trace elements and the like, in addition to the sugar cane extract. The nitrogen source may be an organic nitrogen or inorganic nitrogen, preferably soytone and sodium nitrate, and more preferably sodium nitrate. The sodium nitrate may have a concentration of 1-10 g/l in the medium. Sodium nitrate shows high absorption efficiency by Agaricus bisporus mycelium, is inexpensive, and maintains the pH of the medium constant while the pH of the medium changes when other ammonium-based nitrogen sources are used. When the concentration of sodium nitrate is less than 1 g/l, a nitrogen source required for the growth of Agaricus bisporus mycelium is deficient. When the concentration of sodium nitrate is greater than 10 g/l, it does not greatly affect the growth of Agaricus bisporus mycelium. Thus, it is preferred to use 1 g/l to 10 g/l sodium nitrate in the medium.

The medium may comprise a yeast extract at a concentration of 1-10 g/l.

The culturing of Agaricus bisporus mycelium may be conducted at an initial pH of the medium of 6.0 to 6.5, at a culture temperature of 25-28° C., while stirring at a stirring velocity of 150-250 rpm.

Agaricus bisporus mycelium may be dispersed using a blender before inoculation. While an inoculum is cultured, big agglomerates are formed with a growth of the mycelium, thereby making it difficult to supply oxygen. Therefore, to prevent this oxygen supply limitation, the mycelium is needed to be dispersed to small particles before inoculation.

The culturing of Agaricus bisporus mycelium may be conducted until a desired amount of mycelium is obtained. For example, a culture period may be generally 3-10 days, and preferably 3-6 days. According to an embodiment of the present invention, a culture period of 3-6 days is required to obtain a desired maximum yield of Agaricus bisporus mycelium. Therefore, a culture period of Agaricus bisporus mycelium according to the present invention can be much reduced, compared to the prior art in which a culture period of 14-15 days is required to obtain a desired maximum yield of Agaricus bisporus mycelium.

The culturing of Agaricus bisporus mycelium may further comprise pre-culturing the Agaricus bisporus mycelium or spores thereof in a liquid medium comprising potato dextrose broth of 15-25 g/l, yeast extract of 1-10 g/l, malt extract of 2-5 g/l, and soytone of 2-5 g/l.

Pre-culture refers to a preliminary culture to obtain mushroom seed culture from the primary strain before a main culturing of Agaricus bisporus mycelium is performed. Primary strain refers to a strain from which a seed culture is originated. Seed culture refers to a pure culture of the desired strain, i.e. primary strain, and an inoculum refers to a seed culture to be inoculated to a medium for proliferation.

The pre-culture may be conducted at an initial pH of 6.0 to 6.5, at a culture of temperature 25-28° C., and while stirring at a stirring velocity of 150-250 rpm. The obtained mycelium can be dispersed using a blender. During the pre-culture, big agglomerates may be formed due to a growth of the mycelium, and thereby oxygen supply may be limited. Therefore, to prevent this oxygen supply limitation, the mycelium is needed to be dispersed to small particles. The pre-culture can be conducted until a desired amount of seed culture for proliferation is obtained, and the pre-culture generally requires 3-4 days.

The present invention also provides a medium for culturing Agaricus bisporus mycelium. The medium comprises sugar cane extract, and may preferably comprise the sugar cane extract in a concentration of 10-30 g/l. The medium may further comprise sodium nitrate as a nitrogen source. Preferably, the medium may comprise the sodium nitrate in a concentration of 1-10 g/l. In addition, the medium may further comprise a yeast extract in a concentration 1-10 g/l. The medium may have an initial pH of 6.0-6.5.

A medium according to an embodiment of the present invention may preferably comprise sugar cane extract in a concentration of 15-25 g/l and sodium nitrate in a concentration of 5-10 g/l, and more preferably further comprise a yeast extract in a concentration of 5-10 g/l.

The present invention also provides a medium for pre-culturing Agaricus bisporus mycelium or spores thereof, comprising a potato dextrose broth of 15-25 g/l, yeast extract of 1-10 g/l, malt extract of 2-5 g/l, and soytone of 2-5 g/l.

### BRIEF DESCRIPTION OF THE DRAWINGS

The above and other features and advantages of the present invention will become more apparent by describing in detail exemplary embodiments thereof with reference to the attached drawings in which:

FIG. 1 is an electron microscopic image of Agaricus bisporus mycelium according to an embodiment of the present invention;

FIG. 2 illustrates the growth of Agaricus bisporus mycelium with respect to a culture temperature, according to an embodiment of the present invention;

FIG. 3 illustrates the growth of Agaricus bisporus mycelium with respect to an initial pH, according to an embodiment of the present invention;

FIG. 4 illustrates the growth of Agaricus bisporus mycelium with respect to a culture period, according to an embodiment of the present invention;

FIG. 5 illustrates the growth of Agaricus bisporus mycelium with respect to carbon source types in a medium, according to an embodiment of the present invention;

FIG. 6 illustrates the growth of Agaricus bisporus mycelium with respect to a concentration of sugar cane extract which is used as a carbon source, according to an embodiment of the present invention;

FIG. 7 illustrates the growth of Agaricus bisporus mycelium with respect to nitrogen source types in a medium, according to an embodiment of the present invention;

FIG. 8 illustrates the growth of Agaricus bisporus mycelium with respect to a concentration of sodium nitrate which is used as a nitrogen source, according to an embodiment of the present invention; and

FIG. 9 illustrates the growth of Agaricus bisporus mycelium with respect to a stirring velocity of a bioreactor, according to an embodiment of the present invention.

### BEST MODE FOR CARRYING OUT THE INVENTION

Hereinafter, the present invention will be described more specifically with reference to the following Examples. The following Examples are for illustrative purposes and are not intended to limit the scope of the invention.

### EXAMPLE 1

### Isolation of Strain and Preparation of Inoculum

A strain of Agaricus bisporus was obtained via tissue culture, and the obtained strain was cultured in a potato dextrose agar (PDA) at 25° C. for 3 weeks, and then the obtained Agaricus bisporus mycelium was stored at 4° C.

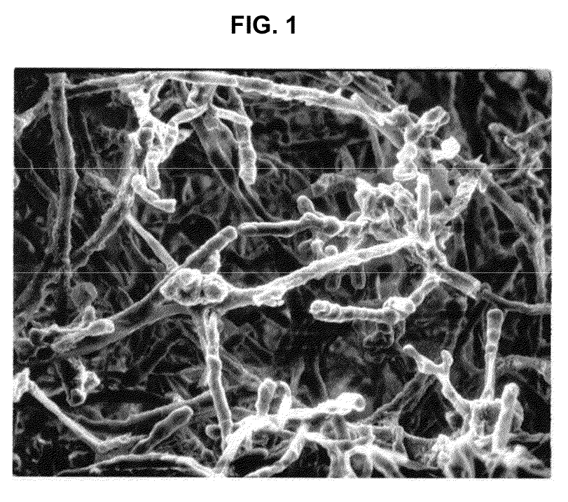

FIG. 1 is an electron microscopic image of Agaricus bisporus mycelium according to an embodiment of the present invention.

To prepare an inoculum using a solid culture, a part of the mycelium was separated from a center portion of a PDA plate medium that was refrigeration stored and inoculated into a solid medium, and then cultured in a thermostat at a temperature of 25° C. to obtain an inoculum. When an inoculum was prepared from Agaricus bisporus mycelium through a liquid culture, 100 ml of a PDBYMS medium comprising 20 g/l of potato dextrose broth (PDB), 10 g/l of yeast extract, 5 g/l of malt extract and 5 g/l of soytone was autoclaved in a 500 ml Erlenmeyer flask at 121° C. for 15 minutes, and then the mycelium was inoculated thereto and cultured at a stirring velocity of 200 rpm. In the following examples, a remaining portion of the medium besides particularly specified components was distilled water.

### EXAMPLE 2

### Seed Pre-culture

To examine optimum conditions for a seed pre-culture, mediums having compositions shown in Table 1 below were prepared. 100 ml of each of the prepared mediums was added to a 500 ml Erlenmeyer flask, and then autoclaved at 121° C. for 15 minutes. 1% (v/v) of a homogenized inoculum under sterile condition was then inoculated thereto, and cultured in a thermostat with a temperature of 25° C. with shaking at 200 rpm for 4 days. To measure the growth of the mycelium, the culture medium was filtered with a gauze, and separated at 1,500 rpm for 10 minutes using an ultracentrifuge, and then dried in a dry oven at a temperature of 60° C. for 24 hours to measure a dry weight of the mycelium.

TABLE 1

| Experi- | | Yeast | Malt | | | Dry |
|---|---|---|---|---|---|---|
| mental | | extract | extract | Soytone | weight | weight |
| group | PDB(g/l) | (g/l) | (g/l) | (g/l) | (g/100 ml) | (g/100 ml) |
| P1 | 0 | 10 | 5 | 5 | 6.49 | 0.46 |
| P2 | 5 | 10 | 5 | 5 | 7.50 | 0.65 |
| P3 | 10 | 10 | 5 | 5 | 8.35 | 0.93 |
| P4 | 15 | 10 | 5 | 5 | 7.65 | 1.01 |

As shown in Table 1, when the medium comprising 24 g/l of PDB, 10 g/l of yeast extract, 2-5 g/l of malt extract and 2-5 g/l of soytone was used, the growth of the mycelium is the highest.

Therefore, the medium comprising 24 g/l of PDB, 10 g/l of yeast extract, 5 g/l of malt extract and 5 g/l of soytone was used as a medium for pre-culturing of seed culture. In addition, as a basal medium of the culture used to set optimum culture conditions, a PDBYMS medium comprising 24 g/l of PDB, 10 g/l of yeast extract, 5 g/l of malt extract and 5 g/l of soytone was used.

Agglomerates formed as Agaricus bisporus mycelium grew in the pre-culture were dispersed using a blender before the main culture. The blender was a small mixer type as disclosed in Korean Patent Publication No. 1998-0072112.

### EXAMPLE 3

### Set Up Optimum Conditions of the Main Culture

1. Optimum Temperature

To examine an optimum culture temperature for growing Agaricus bisporus mycelium, 100 ml of the basal medium was added to a 500 ml Erlenmeyer flask, and then autoclaved at 121° C. for 15 minutes. 1% (v/v) of a homogenized inoculum under sterile condition was then inoculated thereto, and cultured while shaking at 200 rpm in a thermostat at a temperature of 25° C. for 4 days to examine the growth of the mycelium. This process was repeated under the same conditions except the temperatures of 28□ and then 30° C. were used.

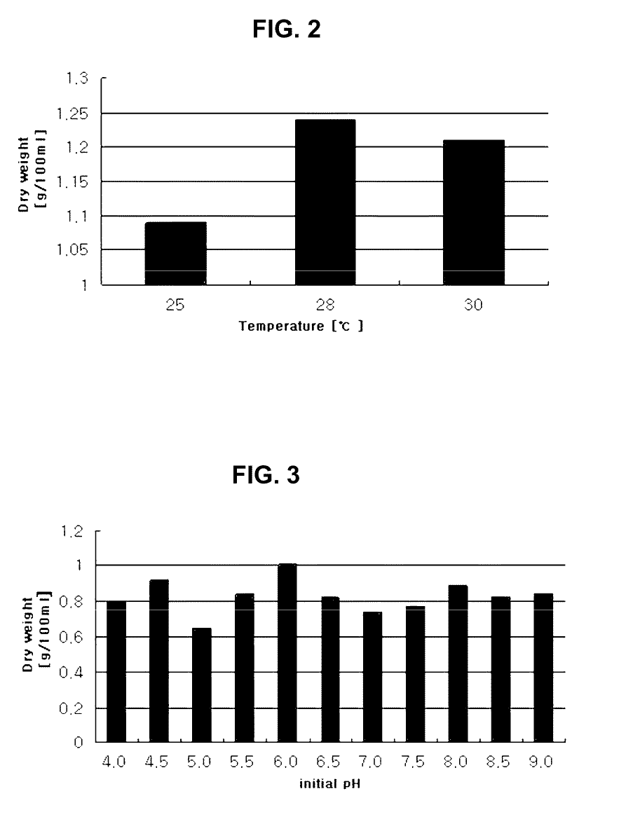

FIG. 2 illustrates the growth of Agaricus bisporus mycelium with respect to a culture temperature, according to an embodiment of the present invention.

Referring to FIG. 2, the growth of the mycelium was excellent at 28° C. and 30° C., and particularly showed the highest value at 28° C.

2. Optimum pH

To examine an optimum initial pH for growing Agaricus bisporus mycelium, 100 ml of the basal medium was added to a 500 ml Erlenmeyer flask at an initial pH of 4.0. The medium was then autoclaved at 121° C. for 15 minutes, and 1% (v/v) of a homogenized inoculum under sterile condition was inoculated thereto, and then cultured while shaking at 25° C. and at 200 rpm for 4 days to examine the growth of the mycelium. This process was repeated under the same conditions except that the pH was adjusted between 4.5 and 9.0 at increments of 0.5 using phosphoric acid and 50% of NaOH.

FIG. 3 illustrates the growth of Agaricus bisporus mycelium with respect to an initial pH, according to an embodiment of the present invention. Referring to FIG. 3, the growth of the mycelium was observed the highest at pH 6.0.

3. Culture Period

To examine how a culture period affects the growth of Agaricus bisporus mycelium, 100 ml of the basal medium was added to each of 500 ml Erlenmeyer flasks, and then an initial pH was adjusted to 6.0-6.5. The medium was then autoclaved at 121° C. for 15 minutes, and 1% (v/v) of a homogenized inoculum under sterile condition was inoculated thereinto, and then cultured while shaking at 25° C. and at 200 rpm for 10 days to examine the growth of the mycelium.

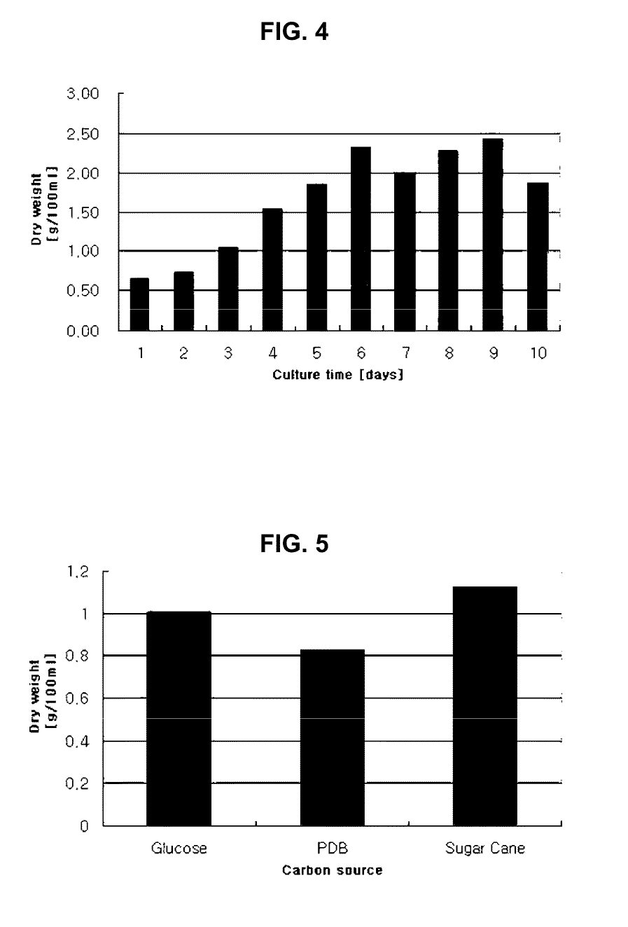

FIG. 4 illustrates the growth of Agaricus bisporus mycelium with respect to a culture period, according to an embodiment of the present invention. Referring to FIG. 4, the growth of the mycelium slowly increased until a culture period of 2 days, and then rapidly increased from the third day, showing a typical exponential phase. A maximum amount of the mycelium was 2.43 g/100 ml on the 9^{th} day, and the growth of the mycelium declined afterwards. From the results shown in FIG. 4, a culture period of 6 days showing a slight difference from an amount of the mycelium at a culture period of 9 days was determined as an optimum culture period.

4. Selection of Carbon Source and its Optimum Concentration

To select an optimum medium for the present culture, the basal medium was modified to examine its effect on the growth of the mycelium.

That is, 20 g/l of PDB as a carbon source was mixed with 10 g/l of yeast extract, 5 g/l of malt extract and 5 g/l of soytone. The pH of the medium was then adjusted to 6.0-6.5, and 100 ml of the medium was added to 500 ml Erlenmeyer flasks and then autoclaved at 121° C. for 15 minutes to prepare an experimental medium. Then, 1% (v/v) of a homogenized inoculum under sterile condition was inoculated thereto, and then cultured at 25° C. while shaking at 200 rpm for 4 days to examine the growth of the mycelium. This process was repeated under the same conditions except that glucose and then sugar cane extract (CJ Corporation) were used as the carbon source.

FIG. 5 illustrates the growth of Agaricus bisporus mycelium with respect to carbon source types in a medium, according to an embodiment of the present invention. Referring to FIG. 5, when sugar cane extract was used as a carbon source, the growth of the mycelium was the most efficient.

Next, to select an optimum concentration of the carbon source, mediums respectively including 1 g/l, 5 g/l, 10 g/l, 15 g/l and 20 g/l of the sugar cane extract mixed with 10 g/l of yeast extract, 5 g/l of malt extract and 5 g/l of soytone were prepared. A pH of each medium was then adjusted to 6.0-6.5, and 100 ml of each of the mediums was added to a 500 ml Erlenmeyer flask and then autoclaved at 121° C. for 15 minutes to prepare a series of mediums each of which has a different concentration of the carbon source. Then, the growth of mycelium was examined in the same manner as in the experiment on selection of carbon source.

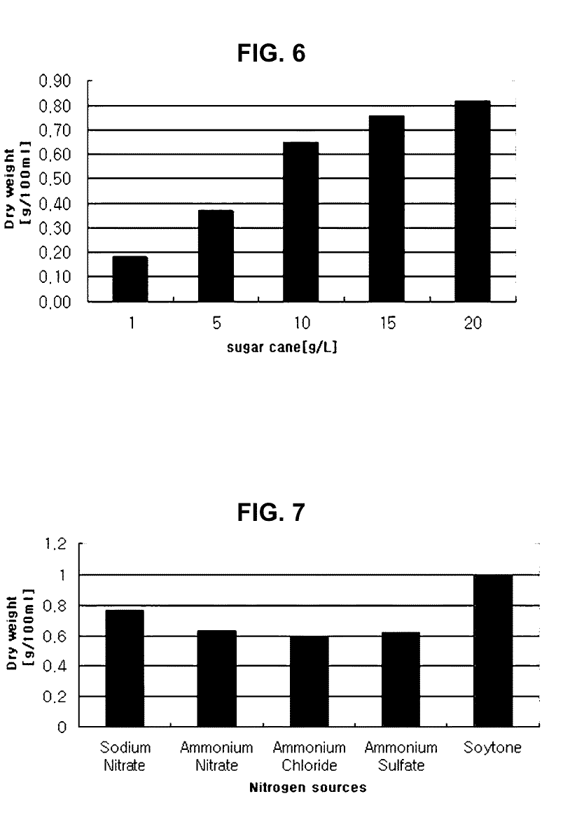

FIG. 6 illustrates the growth of Agaricus bisporus mycelium with respect to a concentration of sugar cane extract used as a carbon source, according to an embodiment of the present invention. Referring to FIG. 6, when a concentration of the sugar cane extract was 10-20 g/l, the growth of the mycelium was excellent.

5. Selection of Nitrogen Source and its Optimum Concentration

To examine optimum nitrogen source and concentration for growing Agaricus bisporus mycelium, 20 g/l of sugar cane extract, that is, an optimum carbon source, was added to a PDBYMS medium. 10 g/l of sodium nitrate as a nitrogen source was then added thereto. The pH of the medium was adjusted to 6.0-6.5, and 100 ml of the medium was added to 500 ml Erlenmeyer flasks and then autoclaved at 121° C. for 15 minutes to prepare a medium. This process was repeated under the same conditions except that ammonium nitrate, ammonium chloride, ammonium sulfate and then soytone were used as the nitrogen source. Then, the growth of mycelium was examined in the same manner as in the experiment on selection of carbon source.

FIG. 7 illustrates the growth of Agaricus bisporus mycelium with respect to nitrogen source types in a medium, according to an embodiment of the present invention. Referring to FIG. 7, when soytone was used as a nitrogen source, the growth of mycelium is the highest, followed by sodium nitrate. When the economical factor as well as the growth effect is considered, sodium nitrate may be most preferred as a nitrogen source.

Next, to select an optimum concentration of the nitrogen source, the growth of mycelium was examined in the same manner as in the experiment on selection of nitrogen source, except that 1 g/l, 3 g/l, 5 g/l, 7 g/l and 10 g/l of sodium nitrate were used.

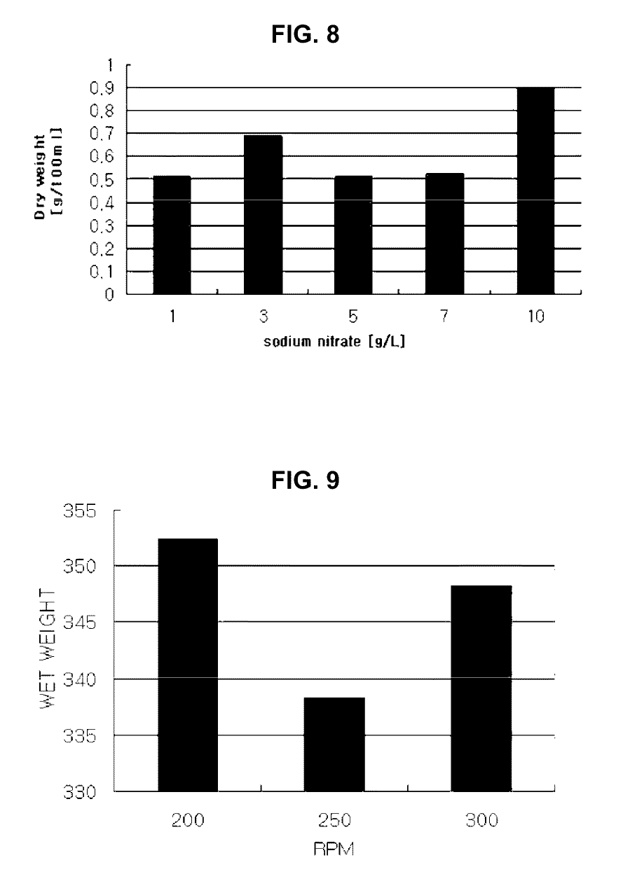

FIG. 8 illustrates the growth of Agaricus bisporus mycelium with respect to a concentration of sodium nitrate used as a nitrogen source, according to an embodiment of the present invention. Referring to FIG. 8, when the concentration of sodium nitrate was 10 g/l, the growth of mycelium was the highest. An additional experiment showed that when a medium comprised 10 g/l of sodium nitrate as a nitrogen source, and 5 g/l of yeast extract, the growth of mycelium reached the highest.

### EXAMPLE 4

Liquid Culture of Agaricus bisporus Mycelium in a Bioreactor-optimum Impeller Rotation Number

To mass culture Agaricus bisporus mycelium, the mycelium was cultured while being stirred in a bioreactor.

BIOFLO IIc Batch/Continuous Fermentor (New Brunsdwick Scientific.) was used as the bioreactor. A medium comprising 20 g/l of sugar cane extract, 10 g/l of sodium nitrate and 5 g/l of yeast extract in distilled water was used as a culture medium, and 1% (v/v) of a homogenized inoculum under sterile condition was inoculated into 2 l of the medium. Then, the inoculum was cultured with an air supply of 0.25 v/v/m at an impeller rotation speed of the bioreactor of 150 rpm for 4 days to measure a wet weight. This process was repeated under the same conditions except that impeller rotation speeds of 200 rpm, 250 rpm and 300 rpm were used, respectively.

FIG. 9 illustrates the growth of Agaricus bisporus mycelium with respect to an impeller rotation speed of a bioreactor, according to an embodiment of the present invention. Referring to FIG. 9, when the impeller rotation speed was 200 rpm, a maximum amount of mycelium was obtained.

### INDUSTRIAL APPLICABILITY

According to the method of culturing Agaricus bisporus mycelium of the present invention, a large amount of Agaricus bisporus mycelium can be efficiently cultured within a short period of time.

1. A method of culturing Agaricus bisporus mycelium, comprising culturing Agaricus bisporus mycelium or spores thereof in a liquid medium comprising sugar cane extract.

2. The method of claim 1, wherein the sugar cane extract has a concentration of 10-30 g/l.

3. The method of claim 1, wherein the medium further comprises sodium nitrate as a nitrogen source.

4. The method of claim 3, wherein the sodium nitrate has a concentration of 1 -10 g/l.

5. The method of claim 1, wherein the medium comprises yeast extract in a concentration of 1-10 g/l.

6. The method of claim 1, wherein the culturing of Agaricus bisporus mycelium is conducted at an initial pH of 6.0 to 6.5, at a culture temperature 25-28° C., while stirring at a stirring velocity of 150-250 rpm.

7. The method of claim 1, wherein the Agaricus bisporus mycelium is dispersed using a blender.

8. The method of claim 1, wherein the culturing of Agaricus bisporus mycelium is conducted for 3-6 days before completion.

9. The method of claim 1, further comprising preparing a mushroom seed culture by pre-culturing the Agaricus bisporus mycelium or spores thereof in a liquid medium comprising potato dextrose broth of 15-25 g/l, yeast extract of 1-10 g/l, malt extract of 2-5 g/l, and soytone of 2-5 g/l.

10. The method of claim 9, wherein the pre-culturing of the Agaricus bisporus mycelium or spores thereof is conducted at an initial pH of 6.0 to 6.5, at a culture temperature 25-28° C., while stirring at a stirring velocity of 150-250 rpm.

11. The method of claim 10, further comprising dispersing the pre-cultured mushroom mycelia using a blender.

12. A medium for culturing Agaricus bisporus mycelium, comprising sugar cane extract of 10-30 g/l and sodium nitrate of 1-10 g/l.

13. The medium of claim 12, further comprising yeast extract in a concentration of 1-10 g/l.

14. A medium for pre-culturing Agaricus bisporus mycelium or spores thereof, comprising potato dextrose broth of 15-25 g/l, yeast extract of 1-10 g/l, malt extract of 2-5 g/l, and soytone of 2-5 g/l.
